(19) United States
(12) Patent Application Publication
(10) Pub. No.: US 2024/0390850 A1
(43) Pub. Date: Nov. 28, 2024

(54) Carbon Capture Device and a Method of Using the Carbon Capture Device for Carbon Capture

(71) Applicant: Singapore University of Technology And Design, Singapore (SG)

(72) Inventors: Mei Chee Tan, Singapore (SG); Hong Yee Low, Singapore (SG); Daniel Wirawan, Singapore (SG); Anaqi Pek, Singapore (SG); Jian Ting Lai, Singapore (SG)

(21) Appl. No.: 18/690,878

(22) PCT Filed: Sep. 15, 2022
(86) PCT No.: PCT/SG2022/050660

§ 371 Date: Mar. 11, 2024

(30) Foreign Application Priority Data
Sep. 16, 2021 (SG) 10202110219R

(51) Int. Cl. B01D 53/83; B01D 53/62

(52) U.S. Cl. CPC B01D 53/83; B01D 53/62; B01D 2253/106; B01D 2253/202; B01D 2253/25; B01D 2253/304; B01D 2257/504; B01D 2258/06

(57) ABSTRACT

A carbon capture device is described. The carbon capture device comprises a carbon capture film for capturing carbon dioxide; and an exposure mechanism for exposing a portion of the carbon capture film to a surrounding environment for capturing carbon dioxide. The exposure mechanism comprises a receiver for receiving an exposed portion of the carbon capture film and a storage for holding an unexposed portion of the carbon capture film, wherein the receiver is adapted to be connected to a portion of a leading end of the carbon capture film and to convey the unexposed portion of the carbon capture film from the storage to the receiver for exposing the portion of the carbon capture film to the surrounding environment. A method of using the carbon capture device for carbon capture is also described.

### TECHNICAL FIELD

The present disclosure relates to a carbon capture device and a method of using the carbon capture device for carbon capture.

### BACKGROUND

Atmospheric CO₂ accounts for about 20% of greenhouse gases, and rising CO₂ concentration in our atmosphere is an increasingly urgent global environmental challenge. Existing CO₂ capture solutions primarily focus on point source capture utilizing chemical/process plant-based separation processes. Direct air capture (DAC) has been proposed as a complementary solution to point source capture. However, majority of reported DAC solutions are also based on chemical plant-based separation processes. These chemical plant-based separation processes are largely governed by conventional process design constraints and requirements to allow maximum CO₂ capture through separators (e.g., strippers, adsorption columns) that require a large footprint and are highly energy intensive. These separation processes have largely been designed for the capture of CO₂ from large point sources such as exhaust from power plants. Consequently, today's carbon capture solutions are not applicable to land-scarce cities spaces.

It is therefore desirable to provide a carbon capture device and a method of using the carbon capture device for carbon capture which addresses the aforementioned problems and/or provides a useful alternative.

Furthermore, other desirable features and characteristics will become apparent from the subsequent detailed description and the appended claims, taken in conjunction with the accompanying drawings and this background of the disclosure.

### SUMMARY

Aspects of the present application relate to a carbon capture device and a method of using the carbon capture device for carbon capture.

In accordance with a first aspect, there is provided a carbon capture device comprising a carbon capture film for capturing carbon dioxide; and an exposure mechanism for exposing a portion of the carbon capture film to a surrounding environment for capturing carbon dioxide, the exposure mechanism comprising a receiver for receiving an exposed portion of the carbon capture film and a storage for holding an unexposed portion of the carbon capture film, wherein the receiver is adapted to be connected to a portion of a leading end of the carbon capture film and to convey the unexposed portion of the carbon capture film from the storage to the receiver for exposing the portion of the carbon capture film to the surrounding environment.

Thus, the described embodiment provides a carbon capture device for capturing carbon dioxide from a surrounding environment. By using a carbon capture film and exposing at least a portion of it to the surrounding environment, passive direct capture of carbon dioxide (CO₂) from the surrounding environment is achieved. The use of a carbon capture film for carbon dioxide capture also provide other advantages. First, the carbon capture film is simple to use and install, and its size can be customised. This means that the carbon capture device can be made portable, and can also be designed to be integrated into an existing built-environment and building infrastructure such as office spaces, underground carpark, air handling unit, public transport etc. as well as large point sources (e.g. exhaust from chemical plants, power plants etc.). The carbon capture device can also be modularised to form a part of a distributed direct air capture network for integrating with buildings and infrastructures with different carbon capture needs. The carbon capture device, which utilises a carbon capture film for CO₂ capture, also has a low energy footprint, since little or no energy is required to be provided to the carbon capture film for passive CO₂ capture. Unlike point-source carbon capture solutions (e.g., at exhaust of power plants) which are based on corrosive liquid chemicals or bulk inorganic powder/particles, the carbon capture device of the present embodiment can be based on a non-corrosive, light-weight and freestanding carbon capture film. Further, in an embodiment, the exposure mechanism provides a means for utilising the carbon capture film in a systematic way to control and vary a rate of CO₂ capture and release depending on specific needs. This exposure mechanism creates a synergy with the carbon capture film's intrinsic CO₂ capture kinetics and capacity, hence enabling the tailoring of the carbon capture dynamic of the carbon capture device according to the environmental requirements and constraints. As will be shown in more detail later, the exposure mechanism of the carbon capture device aids in enhancing or maximising a carbon capture or carbon release performance based on a separation zone characteristic of the carbon capture film.

The carbon capture device may comprise a frame adapted to hold the carbon capture film and the exposure mechanism, the frame having an exposure window for exposing the portion of the carbon capture film.

The carbon capture device may comprise a receiver compartment for housing the exposed portion of the carbon capture film and a storage compartment for housing the unexposed portion of the carbon capture film.

The carbon capture device may comprise a fan for directing air flow from the surrounding environment towards the portion of the carbon capture film. The fan can be used for either carbon capture or carbon release operation of the carbon capture device. The fan, for example whether it is switched on and its operating speed, can also be used as parameters to alter a separation zone of the carbon capture film. This provides a handle to customise a carbon capture or a carbon release process as provided by the exposure mechanism of the carbon capture device.

The carbon capture device may comprise a heater for providing heat to the exposed portion of the carbon capture film for releasing the carbon dioxide captured in the exposed portion of the carbon capture film. The heater or heating element provides a means for releasing carbon dioxide captured in the carbon capture film.

The carbon capture device may comprise one or more functional layers, the one or more functional layers being adapted to separate other gaseous molecules, liquids or particles. These one or more functional layers (e.g. moisture capture, odour removal etc.) thereby provide additional functions of the carbon capture device.

The receiver and the storage may be in the form of elongated rollers. The elongated rollers may function as a storage for the unexposed portion of the carbon capture film (e.g. at the storage) and a storage for the exposed portion of the carbon capture film (e.g. at the receiver) as the unexposed portion of the carbon capture film is conveyed from the storage to the receiver. This eases operations of the carbon capture device for its carbon capture and/or carbon release operations.

The carbon capture device may comprise a motor adapted to operationally connect to the receiver for causing the receiver to convey the unexposed portion of the carbon capture film from the storage to the receiver.

The carbon capture device may comprise a motor speed controller connected to the motor for controlling a speed for conveying the unexposed portion of the carbon capture film from the storage to the receiver. The motor speed controller therefore provides a means to control a conveyance speed of the carbon capture film (e.g. from the storage to the receiver for a carbon capture operation or from the receiver to the storage for a carbon release operation) which can be used as a handle to alter a separation zone of the carbon capture film for customising its use in relation to its ambient conditions.

The carbon capture device may comprise a power source for powering the motor. The power source includes a battery or other energy storage or power supply.

The carbon capture device may comprise a direction controller for switching a rotation direction of the motor to cause the receiver to convey the exposed portion of the carbon capture film from the receiver to the storage. This provides a means to change an operation of the carbon capture device (e.g. from carbon capture to carbon release) in-situ without having to remove/swap the receiver and the storage rollers.

The carbon capture device may include a portable carbon capture device.

The carbon capture device may be adapted to be integrated to an infrastructure.

The carbon capture film may include one or more of: a textured surface, a porous structure, a bilayer structure comprising a carbon capturing layer formed on an inert support layer and a plurality of carbon capturing particles mixed within a porous support layer. The carbon capture film can be customised to suit the needs of its application (e.g. considering the operating time frame, ambient conditions/environment etc.).

In accordance with a second aspect, there is provided a system comprising two or more of the aforementioned carbon capture devices for capturing carbon from a surrounding environment.

In accordance with a third aspect, there is provided a method of using a carbon capture device for carbon capture, the carbon capture device comprising a carbon capture film for capturing carbon dioxide and an exposure mechanism for exposing a portion of the carbon capture film to a surrounding environment for capturing carbon dioxide, the exposure mechanism comprising a receiver for receiving an exposed portion of the carbon capture film and a storage for holding an unexposed portion of the carbon capture film, the method comprising: providing the unexposed portion of the carbon capture film to the storage; connecting a portion of a leading end of the carbon capture film to the receiver; and conveying the unexposed portion of the carbon capture film from the storage to the receiver for exposing the portion of the carbon capture film to the surrounding environment.

Where the receiver of the carbon capture device may include an elongated receiving roller and the storage of the carbon capture device may include an elongated storage roller, the elongated receiving roller and the elongated storage rollers may be placed parallel to each other.

The method may comprise providing the carbon capture device in a flat orientation wherein a longitudinal plane of the portion of the carbon capture film is parallel to an air flow direction of the surrounding environment.

The method may comprise providing the carbon capture device in a perpendicular orientation wherein a direction of conveyance of the unexposed portion of the carbon capture film from the storage to the receiver is perpendicular to the air flow direction.

The method may comprise providing the carbon capture device in a parallel orientation wherein a direction of conveyance of the unexposed portion of the carbon capture film from the storage to the receiver is parallel to the air flow direction.

The method may comprise providing the carbon capture device in an erected orientation wherein a longitudinal plane of the portion of the carbon capture film is perpendicular to an air flow direction of the surrounding environment.

The carbon capture device may comprise a fan, and the method may comprise directing, using the fan, an air flow towards the portion of the carbon capture film for capturing carbon dioxide.

The method may comprise: conveying the exposed portion of the carbon capture film from the receiver to the storage; and heating the exposed portion of the carbon capture film to release the captured carbon dioxide.

Heating the exposed portion of the carbon capture film may include heating the exposed portion of the carbon capture film to a temperature ranging from 45° C. to 130° C.

The carbon capture film may include an untextured surface and having a thickness ranging from 50 micrometres (μm) to 200 micrometres (μm), and the method may comprise exposing the portion of the carbon capture film for 15 minutes to 120 minutes.

The method may comprise conveying the unexposed portion of the carbon capture film from the storage to the receiver with a conveyance speed of 2.5 to 5.0 centimetre per minute (cm/min).

Embodiments therefore provide a carbon capture device and a method of using the carbon capture device for carbon capture. By using a carbon capture film and exposing it to the surrounding environment, passive direct capture of carbon dioxide (CO₂) from the surrounding environment is achieved. The use of a carbon capture film for carbon dioxide capture also provides other advantages. First, the carbon capture film is simple to use and install, and its size can be customised. This means that the carbon capture device can be made portable, and can also be designed to be integrated into an existing built-environment and building infrastructure such as office spaces, underground carpark, air handling unit, public transport etc. as well as large point sources (e.g. exhaust from chemical plants, power plants etc.). The carbon capture device can also be modularised to form a part of a distributed direct air capture network for integrating with buildings and infrastructures with different carbon capture needs. The carbon capture device, which utilises a carbon capture film for CO₂ capture, also has a low energy footprint, since little or no energy is required to be provided to the carbon capture film for passive CO₂ capture. Unlike point-source carbon capture solutions (e.g., at exhaust of power plants) which are based on corrosive liquid chemicals or bulk inorganic powder/particles, the carbon capture device of the present embodiment can be based on a non-corrosive, light-weight and freestanding carbon capture film. Further, the exposure mechanism provides a means for utilising the carbon capture film in a systematic way to control a rate of CO₂ capture depending on specific needs. This exposure mechanism creates a synergy with the carbon capture film's intrinsic CO₂ capture kinetics and capacity, hence enabling the tailoring of the carbon capture dynamic of the carbon capture device according to the environmental requirements and constraints. For example, the exposure mechanism of the carbon capture device aids in enhancing or maximising a carbon capture or carbon release performance based on separation zone characteristics of the carbon capture film. In an embodiment, a heating element can be incorporated with the carbon capture device for releasing the captured CO₂ in the carbon capture film, thereby converting the carbon capture device into a CO₂ source. The CO₂ capture and release rate can be controlled and moderated by the exposure mechanism of the carbon capture device based on, for example, a conveyance speed of the carbon capture film, flow conditions and CO₂ concentrations in the surroundings.

### BRIEF DESCRIPTION OF THE DRAWINGS

Embodiments will now be described, by way of example only, with reference to the following drawings, in which:

FIGS. 1A, 1B, 1C and 1D show diagrams illustrating different orientations of a carbon capture device with respect to an incident airflow for non-stagnant conditions in accordance with embodiments, where FIG. 1A shows a diagram illustrating an orientation where the incident airflow is parallel to a longitudinal plane of a carbon capture film of the carbon capture device and with a roll direction of the carbon capture film being perpendicular to an airflow direction of the incident airflow, FIG. 1B shows a diagram illustrating an orientation where the incident airflow is parallel to the longitudinal plane of the carbon capture film and with the roll direction of the carbon capture film being parallel to and in a same direction as the airflow direction (co-current), FIG. 1C shows a diagram illustrating an orientation where the incident airflow is parallel to the longitudinal plane of the carbon capture film and with the roll direction of the carbon capture film being parallel to but in the opposite direction to the airflow direction (counter current), and FIG. 1D shows a diagram illustrating an orientation where the incident airflow is perpendicular to the longitudinal plane of the carbon capture film and the incident air can flow through the carbon capture film of the carbon capture device;

FIGS. 2A and 2B show schematic diagrams of a carbon capture device in accordance with a first embodiment, where FIG. 2A shows a schematic of a carbon capture film within a housing of the carbon capture device, and FIG. 2B shows a schematic of a compartment for electronics (e.g. motor, gears, batteries etc.) and an opening or slot for placement of a fan and/or a heating element of the carbon capture device;

FIG. 3 shows a photograph of a carbon capture device 300 comprising a frame in accordance with a second embodiment;

FIGS. 4A and 4B show schematic diagrams of different components of a carbon capture device in accordance with a third embodiment, where FIG. 4A shows a dissembled carbon capture device illustrating different components of the carbon capture device but excluding a carbon capture film, and FIG. 4B shows a part-assembled carbon capture device with a motor placed on a motor mount for rotating rollers to convey the carbon capture film when the carbon capture device is in use;

FIG. 5 shows an illustration of a frontal plane view of a carbon capture device in accordance with a fourth embodiment;

FIG. 6 shows an illustration of a side plane view of the carbon capture device of FIG. 5 in accordance with the fourth embodiment;

FIGS. 7A and 7B show illustrations of a top plane view of the carbon capture device of FIG. 5 in accordance with the fourth embodiment, where FIG. 7A shows an illustration of the top plane view of the carbon capture device with a covered top, and FIG. 7B shows an illustration of the top plane view of the carbon capture device with an opened top to show an arrangement of a fan and a heating element in the carbon capture device;

FIG. 8 shows an illustration of a perspective back view of the carbon capture device of FIG. 5 in accordance with the fourth embodiment;

FIG. 9 shows illustrations of a roller and its attachments for use with the carbon capture device of FIG. 5 in accordance with the fourth embodiment;

FIG. 10 shows illustrations of different views of the roller of FIG. 9 and a film hook for attaching a carbon capture film to the roller in accordance with the fourth embodiment;

FIG. 11 shows illustrations of a perspective view and a plane view of a roller holder for attaching to the roller of FIG. 9 in accordance with the fourth embodiment;

FIG. 12 shows a graph illustrating different carbon dioxide concentration profiles of a separation zone of a carbon capture device in accordance with an embodiment;

FIGS. 13A, 13B and 13C show graphs of carbon dioxide concentration versus time with and without the use of a carbon capture device for various roll speeds in a lab setup in accordance with embodiments, where FIG. 13A shows a graph of carbon dioxide concentration versus time where a carbon capture device has a roll speed of about 5 cm/min, FIG. 13B shows a graph of carbon dioxide concentration versus time for a non-moving carbon capture film, and FIG. 13C shows a graph of carbon dioxide concentration versus time where a carbon capture device has a roll speed of about 2.5 cm/min;

FIG. 14 shows a graph of carbon dioxide concentration versus time with and without the use of a carbon capture device in a testing facility in accordance with an embodiment; and

FIG. 15 shows a graph of carbon dioxide concentration versus time in a room where carbon dioxide is released from a carbon capture device in accordance with an embodiment.

### DETAILED DESCRIPTION

Exemplary embodiments relating to a carbon capture device and a method of using the carbon capture device for carbon capture are described.

The carbon capture device (also termed “decarbonizer”) functions to capture CO₂ from a surrounding environment. As will be made clear in the later description, the carbon capture device of the present disclosure can be modularised to achieve a distributed direct air capture (DAC) network for customised carbon capture needs. The carbon capture film used can be any suitable film or layer which can function to capture CO₂. In embodiments, this includes a carbon capture film which is adapted to passively capture CO₂. In the present embodiments, a carbon capture composite (C3) film comprising a polymeric support layer and a carbon dioxide capture layer in contact with the polymeric support layer such as described in PCT application no. PCT/SG2018/050340 is used. The PCT application PCT/SG2018/050340 is also incorporated herein in its entirety by reference.

The carbon capture film can be varied and engineered for tuning carbon capture dynamics of the carbon capture device. The carbon capture film can be untextured, or it can be surface textured (e.g. on at least one side of its planar surface) for increasing a total exposed surface or area of the carbon capture film.

Variations on how the carbon capture film can be textured are listed as follows: (i) texture geometries can be non-deterministic geometries or uniform geometries; (ii) the textured surface can include primarily protrusion micro structures with lateral dimensions ranging from 0.1 μm to 50 μm, and a protrusion height ranging from 1 μm to 100 μm; (iii) where a population density of a microstructure is defined based on a spacing between two adjacent protrusions, and the spacing is further defined by a pitch between the two adjacent protrusions (the pitch refers to a centre-to-centre distance between the two adjacent protrusions), a population density of a microstructure can be varied with a pitch of the microstructure ranging from 0.5 μm to 50 μm.

Besides texturing of a carbon capture film, material or structural properties of the carbon capture film can also be varied. For example, a porosity of a carbon capture film can be varied or customised. In an embodiment, a porosity of a carbon capture film includes open porosity (e.g. where at least some of the pores are interconnected to one another). A porous structure of a carbon capture film may include pores of random geometries or pores of a uniform geometry. Pore sizes (i.e. sizes of pores) of a porous structure of a carbon capture film may be based on a random distribution of different sizes or based on a uniform single pore size ranging from 0.1 μm to 20 μm.

A carbon capture film of the present disclosure may comprise one or more layers (e.g. a multi-layer film). In an embodiment, a carbon capture film comprises a bilayer structure. The bilayer structure of the carbon capture film may comprise a carbon capturing layer formed on an inert (e.g. chemically inert) support layer. In an embodiment, the carbon capturing layer is less than 50 μm and comprises porous materials with specific surface areas of more than 500 m²/g. The carbon capturing layer may be bound on a support layer using binders. The support layer may be porous or non-porous, and may have a thickness of more than 50 μm. In another embodiment, a carbon capture film comprises carbon capturing particles or colloids infiltrated within a porous support layer or layers. The carbon capturing particles or colloids may have sizes ranging from 10 nm to 1 μm, and may have specific surface areas of more than 200 m²/g.

An example of a material which can be used for forming a carbon capture film includes a mixture of polyethyleneimine (PEI) and silica nano-particles. A skilled person will appreciate that other suitable materials or material mixtures can be used as long as these materials or material mixtures can function to capture carbon dioxide.

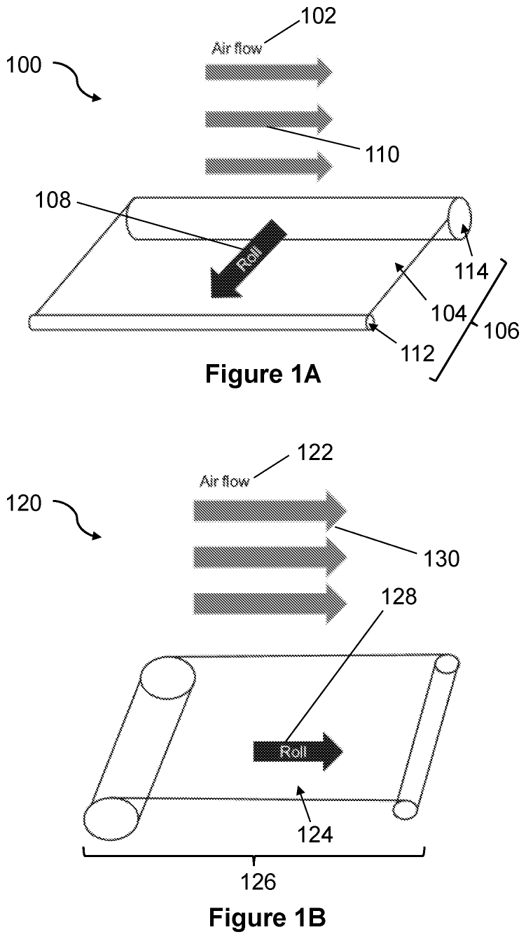

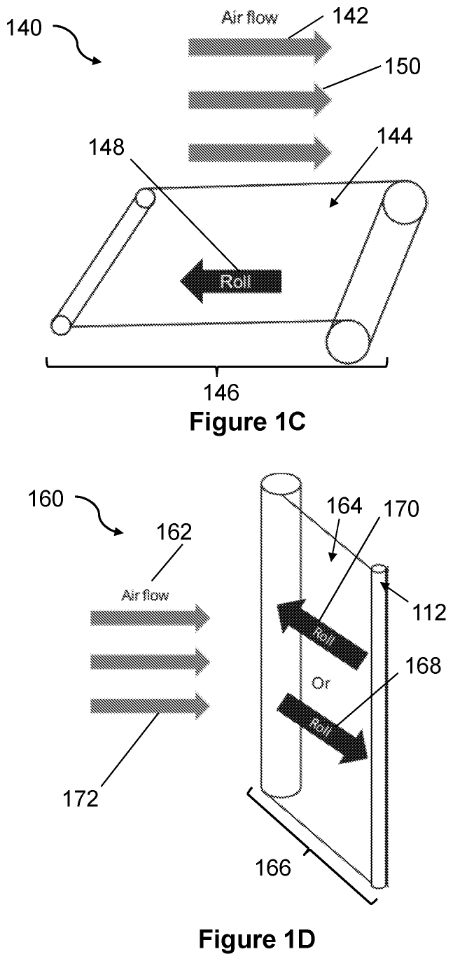

In the present embodiment, a carbon capture device of the present disclosure comprises: (i) a carbon capture film for capturing carbon dioxide and (ii) an exposure mechanism for exposing a portion of the carbon capture film to a surrounding environment for capturing carbon dioxide. The exposure mechanism comprises a receiver for receiving an exposed portion of the carbon capture film and a storage for holding an unexposed portion of the carbon capture film, where the receiver is adapted to be connected to a leading end of the carbon capture film and to convey the unexposed portion of the carbon capture film from the storage to the receiver for exposing the portion of the carbon capture film to the surrounding environment. In an embodiment, as shown in relation to FIGS. 1A to 1D, the receiver and the storage of the exposure mechanism includes two elongated rollers, and the carbon capture film is operationally connected to these two rollers. The two rollers include a receiving roller (i.e. the receiver) adapted to connect to a leading end of the carbon capture film and a storage roller (i.e. the storage) adapted to connect to the other end (i.e. a trailing end) to hold an unexposed portion of the carbon capture film. During operation of the carbon capture device, the rollers are activated to roll or rotate at a predetermined rolling speed, where the receiving roller is adapted to convey unexposed portion of the carbon capture film from the storage roller towards the receiving roller. As the rollers are being rotated, a portion of the carbon capture film between the rollers is exposed to the surrounding in a defined separation zone for interacting with the surrounding air to capture CO₂, thereby reducing the CO₂ concentration of the surrounding environment. As will be appreciated by the skilled person, the exposed portion of the carbon capture film, in the present embodiment, can then be rolled up and stored at the receiving roller after the carbon capture film is utilised to capture CO₂ from the surrounding environment.

The carbon capture device of the present embodiment can be deployed under ambient conditions in a stagnant environment (i.e. with no ambient/external air flow) e.g. within confined spaces, or in a non-stagnant environment (i.e. with an external air flow) e.g. within a building's air handling unit (AHU) with varying flow rates.

In a stagnant environment, the carbon capture device can be oriented in any direction. In non-stagnant conditions (i.e., where the surrounding air is flowing at a certain velocity), the carbon capture device can be oriented either parallel to or perpendicular to a direction of the air flow for use in reducing an amount of CO₂ in the air stream.

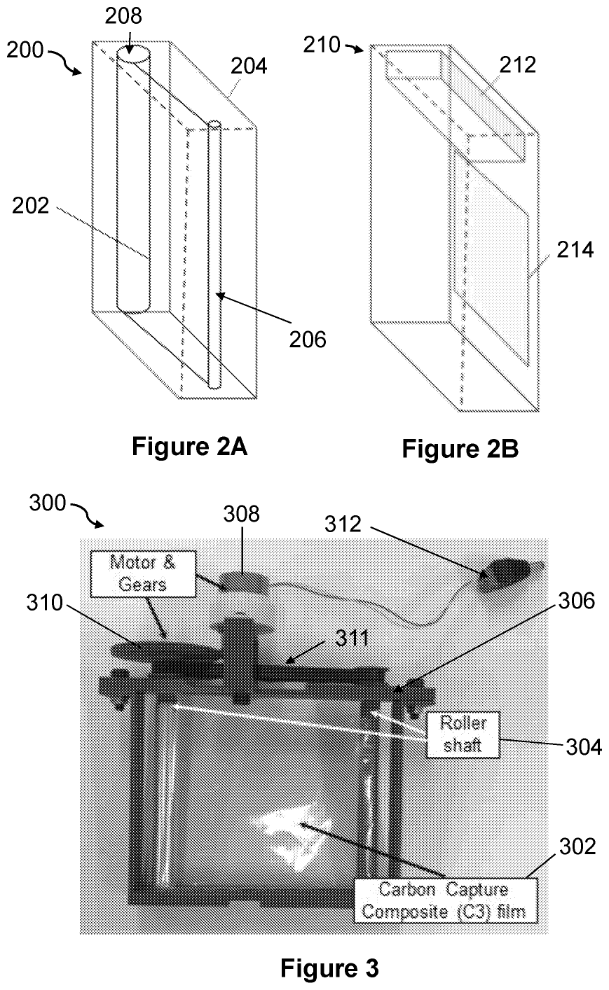

The modular design of the carbon capture device, for example as shown in relation to FIGS. 1A to 1D or FIG. 2A, enables two or more carbon capture devices to be stacked or connected. Multiple units of these carbon capture devices can be placed within a selected space or location, where they can be operated to capture CO₂ from the surrounding environment. This enables the one or more carbon capture devices to be used, depending on a spatial requirement or a carbon capture requirement of the selected space or location. The orientations of the carbon capture devices can also be customised depending on an air-flow requirement (e.g. to make little or no impact of the airflow or flow velocity). Depending on the needs, the carbon capture device may require minimal or no power, or can be battery-powered if directing an air flow is required for the application.

FIGS. 1A, 1B, 1C and 1D show diagrams illustrating different orientations of a carbon capture device with respect to an incident airflow for non-stagnant conditions in accordance with embodiments. FIGS. 1A to 1C show different orientations where the carbon capture device is oriented parallel to the direction of the air flow (i.e. a flat configuration/orientation), while FIG. 1D shows an orientation of the carbon capture device being perpendicular to the direction of the air flow (i.e. an erected configuration/orientation).

FIG. 1A shows a diagram illustrating an orientation 100 where an incident airflow 102 is parallel to a longitudinal plane of a carbon capture film 104 of a carbon capture device 106 and with a roll direction 108 of the carbon capture film 104 being perpendicular to an airflow direction 110 of the incident airflow 102. In other words, the carbon capture device 106 is in a flat orientation with respect to the air flow. Also shown in FIG. 1A is that the present embodiment of the carbon capture device 106 includes a receiving roller 112 adapted to connect to a leading end of the carbon capture film 104 and a storage roller 114 for holding an unexposed portion of the carbon capture film 104. During operation of the carbon capture device 106, the rollers 112, 114 are configured to roll at a predetermined rolling speed, where the receiving roller 112 is adapted to convey unexposed portion of the carbon capture film 104 from the storage roller 114 towards the receiving roller 112, in the roll direction 108. As the rollers 112, 114 are being rotated, a portion of the carbon capture film 104 between the rollers 112, 114 is exposed for interacting with the surrounding air to capture CO₂.

FIG. 1B shows a diagram illustrating an orientation 120 where an incident airflow 122 is parallel to a longitudinal plane of a carbon capture film 124 of a carbon capture device 126 and with a roll direction 128 of the carbon capture film 124 being parallel to the airflow direction 130. In other words, the roll direction 128 and the airflow direction 130 are in a co-current configuration.

FIG. 1C shows a diagram illustrating an orientation 140 where an incident airflow 142 is parallel to a longitudinal plane of a carbon capture film 144 of a carbon capture device 146 and with a roll direction 148 of the carbon capture film 144 being parallel to the air flow direction 150 but in the opposite direction to each other. In other words, the roll direction 148 and the airflow direction 150 are in a counter-current configuration.

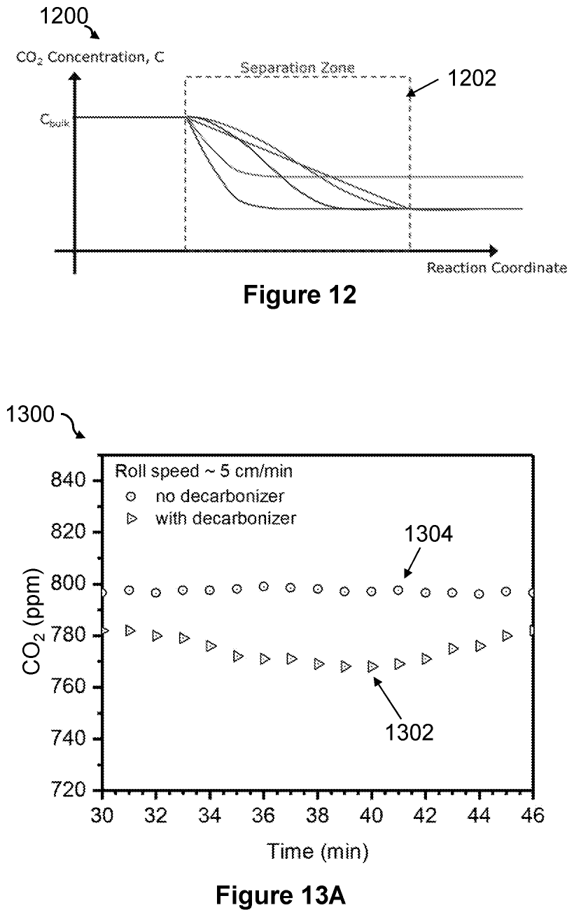

In the parallel/flat configurations as shown in relation to FIGS. 1A, 1B and 1C, a primary separation zone for CO₂ capture is defined based on the region where the carbon capture film 104, 124, 144 is exposed to the incident air flow 102, 122, 142. As illustrated in relation to FIGS. 1A, 1B and 1C, the roll direction 108, 128, 148 of the carbon capture film 104, 124, 144 can be designed to be perpendicular (i.e. FIG. 1A), co-current (i.e., parallel, same direction, i.e. FIG. 1B) or counter-current (i.e., parallel, opposite direction, i.e. FIG. 1C) to the air flow direction 110, 130, 150. The separation region or zone (e.g., length, width) is dependent on the flow conditions, operating conditions of the carbon capture device (e.g. conveyance speed, exposure time of the carbon capture film etc.) and the properties and characteristics (e.g., thickness, surface texture, structural properties) of the carbon capture material. More details about the separation zone is described in relation to FIG. 12 below. Upon exiting the separation region, the CO₂ concentration would be reduced. In these exemplary parallel configurations, an impact of the carbon capture device 106, 126, 146 on a pressure drop and air flow velocity of the incident air is minimal (e.g. close to zero or zero).

FIG. 1D shows a diagram illustrating an orientation 160 where an incident airflow 162 is perpendicular to a longitudinal plane of a carbon capture film 164 of a carbon capture device 166. In this perpendicular/erected configuration, the incident air 162 flows through the carbon capture film 164 of the carbon capture device 166. The carbon capture film 164 can be conveyed in a roll direction 168, 170 that is perpendicular to the air flow direction 172. In an embodiment (not shown in FIG. 1D), the carbon capture device 166 can be rotated in the longitudinal plane by 180° so that e.g. the roll direction 170 will be conveying unexposed portion of the carbon capture film 164 from a storage roller towards a receiving roller. The pressure drops across the carbon capture device 166 would be governed by the characteristics of the carbon capture film 164 (e.g., porosity, thickness) as well as air flow conditions (e.g., flow velocity, pressure, temperature). A separation region in relation to FIG. 1D is defined by a region where the incident airflow is in contact with the carbon capture film 164. Under room temperature conditions, the CO₂ concentration after the air has passed through this separation zone will be reduced. The flow path (e.g., tortuous or non-tortuous) is governed by the characteristics of the carbon capture film 164, a conveyance speed or rolling speed of the carbon capture film 164 and the air flow conditions. In addition to the separation performance (i.e., CO₂ capture kinetics and capacity) and residence time, the tortuosity of the flow path would also dictate the pressure drop across the carbon capture device 166.

The different orientations as illustrated in relation to FIGS. 1A to 1D therefore provide different methods for placing or orientating the carbon capture device in relation to an incident air flow for capturing CO₂ or releasing CO₂ to its surrounding environment. For example, a method can include: (a) providing the carbon capture device in a flat orientation where a longitudinal plane of a portion of the carbon capture film for exposing to the surrounding environment is parallel to an air flow direction of the surrounding environment, (b) providing the carbon capture device in a perpendicular orientation wherein a longitudinal plane of a portion of the carbon capture film for exposing to the surrounding environment is parallel to an air flow direction and a direction of conveyance of the unexposed portion of the carbon capture film from the storage to the receiver is perpendicular to the air flow direction, (c) providing the carbon capture device in a parallel orientation wherein a longitudinal plane of a portion of the carbon capture film for exposing to the surrounding environment is parallel to an air flow direction and a direction of conveyance of the unexposed portion of the carbon capture film from the storage to the receiver is parallel (co-current or counter-current) to the air flow direction, or (d) providing the carbon capture device in an erected orientation wherein a longitudinal plane of the portion of the carbon capture film is perpendicular to an air flow direction of the surrounding environment.

In addition to the carbon capture function as described above, a carbon capture device of the present embodiments can also function as a CO₂ source. For example, CO₂ captured by a carbon capture film of the carbon capture device from one location, can be transported, either in the form of a portable carbon capture device unit or in the form of the rolled and exposed carbon capture film, to another location that requires CO₂. To release the CO₂ in the location that requires CO₂, the exposed/saturated carbon capture film can be conveyed from the receiving roller to the storage roller (e.g. in the roll direction 170 as shown in FIG. 1D), and a low-grade heat (either convective and/or conductive) can be applied to heat the exposed/saturated carbon capture film to release CO₂ from the saturated carbon capture film to the surrounding of the location.

FIGS. 2A to 11 as described below provide different embodiments of a carbon capture device.

A carbon capture device of the present embodiments can be adapted or made into a standalone unit that can be integrated into a building infrastructure or a built environment (e.g. with a scalable unit size ranging from ˜10 cm×10 cm×10 cm to ˜2 m×2 m×2 m). The carbon capture device can be designed as: (1) a modular element capable of being integrated in a flow system (e.g. air ducts, air handling units etc.) or (2) a standalone unit operating at places such as at a roof top or along a service corridor.

As will be clear in relation to the following Figures, besides a carbon capture film and an exposure mechanism including e.g. a receiving roller and a storage roller, the carbon capture device of the present embodiment comprises: (1) a housing, (2) a motor operationally connected to the receiving roller and/or the storage roller, (3) a DC power source (e.g., one or more batteries), (4) an optional modular heating element and (6) an optional modular fan unit.

FIGS. 2A and 2B show schematic diagrams of a carbon capture device in accordance with a first embodiment, for illustrating different components of the carbon capture device. FIG. 2A shows a schematic 200 of a carbon capture film 202 within a housing 204 of the carbon capture device. Also shown in FIG. 2A is that the carbon capture film 202 is mounted on two rollers, a receiving roller 206 and a storage roller 208. As described above, fresh, unexposed, unsaturated carbon capture film can be held by the storage roller 208. During operation of the carbon capture device, the unexposed, unsaturated carbon capture film is conveyed to the receiving roller 206, while being exposed to surrounding environment to capture carbon dioxide. The exposed, saturated carbon capture film is then held by the receiving roller 206 as the exposed, saturated carbon capture film are rolled up at the receiving roller 206.

FIG. 2B shows a schematic 210 of other components of the carbon capture device of FIG. 2A. As shown in FIG. 2B, the carbon capture device comprises a compartment 212 for electronics (e.g. motor, gears, batteries etc.) and an opening or slot 214 for the placement of a fan and/or a heating element (not shown). In the present embodiment, the compartment 212 is shown to be at a top section of the housing 204 but a skilled person should appreciate that other configurations for placing the compartment 212 (e.g. at a bottom or a side of the housing 204) are also possible. The opening or slot 214 are configured to be parallel to the longitudinal plane of the carbon capture film 202 to maximise an effective operation area (e.g. when heating or blowing air at/drawing air from the carbon capture film 202) as shown in FIG. 2B, although the skilled person would appreciate that other configurations (e.g. placement/slots are angled to the longitudinal plane of the carbon capture film 202) are possible.

FIG. 3 shows a photograph of a carbon capture device 300 in a frame configuration in accordance with a second embodiment. As shown in FIG. 3, the carbon capture device 300 comprises a carbon capture film 302 (in the present embodiment, a carbon capture composite (C3) film as described for example at PCT/SG2018/050340) mounted between roller shafts 304. The roller shafts 304 includes a receiving roller and a storage roller, function of which have been described above. The carbon capture film 302 and the roller shafts 304 are mounted on a frame 306. The frame 306 is thus adapted to hold the carbon capture film 302 and an exposure mechanism comprising the roller shafts 304. The frame 306 includes an exposure window at a centre of the frame adapted to expose the carbon capture film 306 when the unexposed portion of the carbon capture film 302 is conveyed from the storage roller to the receiving roller. The exposure window may be defined by a separation between the roller shafts 304 where the portion of the carbon capture film 302 is exposed. In the present embodiment, the roller shafts 304 are not removable from the frame 306. Also shown in FIG. 3 is a motor 308 operationally connected to gears 310 for use in rotating the roller shafts 304 for conveying unexposed portion of the carbon capture film 302 from the storage roller to the receiving roller for exposing the carbon capture film 302 to surrounding air for carbon dioxide capture. As shown in FIG. 3, the carbon capture device 300 also includes a conveyance belt 311 which is operationally connected to the two roller shafts 304 so that rotations caused by the gears 310 can be transmitted to both roller shafts 304 for conveying the carbon capture film 302 from one side to the other (e.g. this can be from the storage roller to the receiving roller for carbon capture or from the receiving roller to the storage roller for carbon release). In the present embodiment, the conveyance belt 311 can be used to meter a rolling speed or a conveyance speed between the rollers (e.g. in a similar manner as a timing belt used in, for example, a car). The motor 308 is electrically connected to a power plug 312 which can be connected to a power source for powering the motor 308. A speed of the motor 308, film characteristics of the carbon capture film 302 and parameters of the surrounding environment (e.g. stagnant vs. non-stagnant condition) will govern the capture or release rate of CO₂.

Although the exposure mechanism used to convey the carbon capture film 302 of the carbon capture device 300 as shown in FIG. 3 is configured using non-removable rollers on a fixed frame 306. It should be appreciated other exposure mechanisms are possible. For example, the exposure mechanism may include (a) removable rollers on a fixed frame, (b) a fixed frame without rollers where the carbon capture film can be conveyed using a bearing-based mechanism, or (c) a bearing-based mechanism or rollers (removable or fixed) being integrated directly to an infrastructure or building without the use of a frame for the carbon capture device. An example of a bearing-based mechanism includes the use of a ball transfer conveyer or ball bearing transfer casters or linear ball bearings, where the carbon capture film can be placed on several ball bearings rotating in a specific direction to convey from a storage end to a receiver end of the carbon capture device. In an embodiment where a bearing-based mechanism is used, a receiver comprises a bar or a pair of linear ball bearings connected to at least a portion of a leading end of the carbon capture film can be translated linearly (e.g. being translated along a pair of tracks fixed to a frame or integrated with an infrastructure) or rotated to convey unexposed carbon capture film from a storage to the receiver of the carbon capture device for exposing a portion of the carbon capture film to the surrounding environment for carbon capture or carbon release. In this case, the carbon capture device may include a window between the storage and the receiver of the carbon capture device for exposing the carbon capture film to the surrounding environment. In embodiments, a storage of a carbon capture device can be in the form of a roller for storing an unexposed portion of a carbon capture film, and/or a receiver of a carbon capture device can be in the form of a roller for storing the exposed portion of the carbon capture film. Although in these cases, the conveyance mechanism may not involve the roller(s) directly and may involve other mechanisms (e.g. the bearing-based mechanism or other mechanisms as discussed above) for conveying the carbon capture film between these rollers.

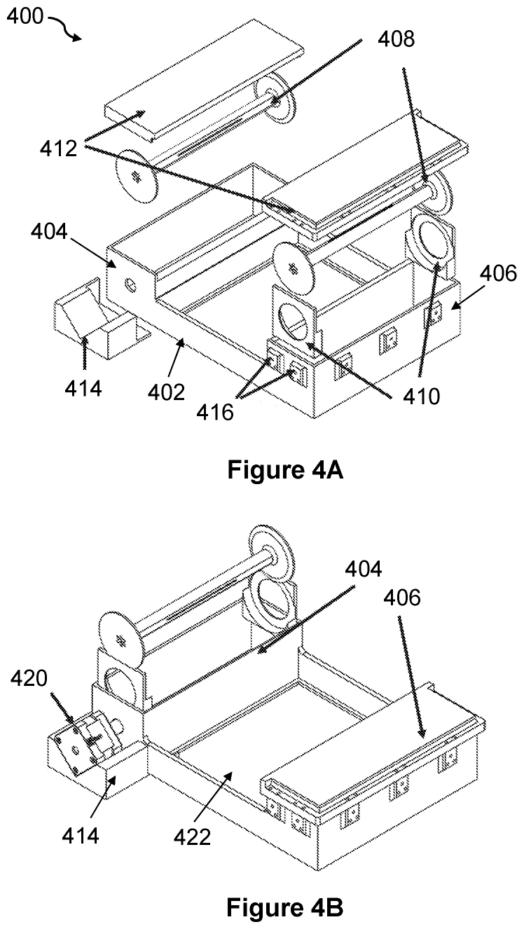

FIGS. 4A and 4B show schematic diagrams of different components of a carbon capture device in accordance with a third embodiment.

FIG. 4A shows a dissembled carbon capture device 400 illustrating its different components but excluding a carbon capture film. The carbon capture device 400 includes similar components as described in relation to the embodiments above but the components are being put together differently in the present embodiment. As shown in FIG. 4A, the carbon capture device 400 comprises a housing 402 having two roller compartments 404, 406. The roller compartments 404, 406 are adapted to house rollers or reels 408. As described above, the rollers/reels 408 are adapted to hold or mount a carbon capture film and to expose the carbon capture film in a systematic manner for capturing carbon dioxide from surrounding air of the carbon capture device 400. FIG. 4A also shows reel inserts 410 for holding the reels 408 when they are placed in the roller compartments 404, 406. The reel inserts 410 are adapted to allow the reels 408 to rotate with ease within the roller compartments 404, 406. The carbon capture device 400 also comprises compartment lids 412 adapted to cover or enclose the reels 408 with the carbon capture film within the roller compartments 404, 406, while leaving a gap between the compartment lids 412 and the roller compartments 404, 406 at an inner side of the roller compartments 404, 406 for conveying a carbon capture film between the reels 408 while the carbon capture device 400 is in use. In an embodiment, rubber flaps can be used to at least partially cover the gap to limit exposure of the carbon capture film (particularly the unexposed portion of the carbon capture film) to the surroundings. This aids particularly to ensure an integrity of the unexposed portion of the carbon capture film. In the present embodiment, a motor mount 414 is provided external to the housing 402. The motor mount 414 is configured to be connected to the housing 402, when in use, and to house or hold a motor in place. This will be further described in relation to FIG. 4B below. The carbon capture device 400 also includes fixtures 416 adapted to be connected to latches for mounting this portable carbon capture device 400. In another embodiment, these fixtures 416 can also be adapted to connect two or more carbon capture devices 400 to form an interconnected network of carbon capture devices 416 for carbon capture.

FIG. 4B shows the carbon capture device 400 being part assembled in accordance with an embodiment. As shown in FIG. 4B, a motor 420 can be placed on the motor mount 414 and is adapted to rotate the reels 408 for exposing the carbon capture film of the carbon capture device of the housing 402 when in use. In an embodiment, the motor 420 together with the motor mount 414 can be attached at the position of the other roller compartment 406, for example, for changing a rotation direction of the rollers 408 or a conveyance direction of the carbon capture film. In the present embodiment, the motor 420 is in the form of a cubic shape and the motor mount 414 has a complementary shape to the motor 420 so that the motor 420 rests on the motor mount 414 and will not rotate when the motor 420 is used in rotating the reels 408. In an embodiment, a bracket can be added to at least partially enclose the motor and is affixed to the motor mount 414 to ensure that the motor 420 is held down and does not move out of the motor mount 414. In an embodiment, adhesives or tapes can be used to hold the motor 420 down to ensure it does not move when in use. FIG. 4B also shows a slot or opening 422, which can be adapted to fit a fan unit and/or a heating element. In the present embodiment, for conveying the unexposed portion of the carbon capture film from a storage roller to a receiving roller, the motor 420 is adapted to be connected to the receiving roller. In an embodiment where the carbon capture device 400 is used to release CO₂, the storage roller can swap position with the receiving roller so that the motor 420 is adapted to be connected to the storage roller for conveying saturated or exposed carbon capture film from the receiving roller towards the storage roller for exposing the saturated carbon capture film (with the application of heat) to release CO₂ to the surroundings. In an embodiment, a rotation direction of the motor 420 can be reversed to convey exposed or saturated carbon capture film from the receiving roller to the storage roller, and with an application of heat, CO₂ can be released. In an embodiment, though not shown in FIGS. 4A and 4B, a conveyance belt can be used to operationally connect the two rollers 408 so that they will rotate synchronously.

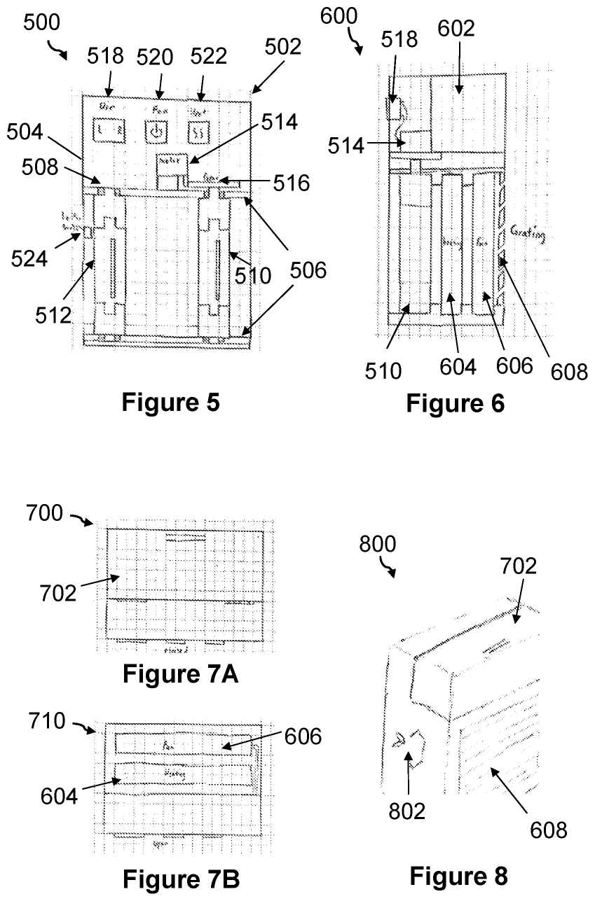

FIGS. 5 to 11 show illustrations in relation to a carbon capture device for showing a lay out, positions and breakdown of each of its component, in accordance with a fourth embodiment.

FIG. 5 shows an illustration of a frontal plane view 500 of a carbon capture device 502 in accordance with the fourth embodiment. Similar to the embodiments as shown in relation to FIGS. 4A and 4B, a carbon capture film is not shown for succinctness. As shown in FIG. 5, the carbon capture device 502 comprises a housing 504. The housing 504 includes a roller mount 506 having slots 508 for mounting rollers 510, 512. As described above, the rollers 510, 512 comprise a receiving roller 510 and a storage roller 512 adapted to hold or mount a carbon capture film and to expose the carbon capture film in a systematic manner for capturing carbon dioxide from surrounding air of the carbon capture device 502. Also shown in FIG. 5 is a motor 514 and its gears 516 which are configured to be operationally connected to the receiving roller 510 for rotating the receiving roller 510 for conveying the carbon capture film between the storage roller 512 and the receiving roller 510. Although not explicitly shown in FIG. 5, the rollers 510, 512 can be connected via a conveyance belt to allow the two rollers 510, 512 to roll and maintain film tension of the carbon capture film. This allows rotation of the carbon capture film in either direction by changing a rotation direction of the motor. In an embodiment, a conveyance belt is not required and the motor can be connected to the storage roller 512 for changing a rotation direction of the rollers to change a conveyance direction of the carbon capture film. At an upper portion of the housing, above the rollers 510, 512, are control buttons for controlling or operating various components of the carbon capture device 502. A direction button 518 is provided to control or change a direction of rotation of the rollers 510, 512. For example, in a first direction (L) of the direction button 518, the receiving roller 510 is adapted to rotate so that unexposed portion of the carbon capture film is conveyed from the storage roller 512 towards the receiving roller 510 to be exposed to the surrounding air for carbon dioxide capture. On the other hand, a second direction (R) of the direction button 518 can reverse the rotation direction of the receiving roller 510 and the storage roller 512, thereby conveying the exposed, saturated carbon capture film from the receiving roller 510 to the storage roller 512. In this case, heat may be applied to release the captured carbon dioxide in a specific environment which requires additional carbon dioxide. Also shown in FIG. 5 is a fan button 520 for switching on and off a fan unit of the carbon capture device 502, and a heat element button 522 for switching on and off a heating element of the carbon capture device 502. In the present embodiment, the carbon capture device 502 is also provided with a limiter switch 524 adapted to manually limit a rotation of the rollers 510, 512 if required.

FIG. 6 shows an illustration of a side plane view 600 of the carbon capture device 502 of FIG. 5 in accordance with the fourth embodiment. Similar components are labelled with the same reference numerals.

As shown in FIG. 6, the carbon capture device comprises an electronics compartment 602 at an upper section of the housing 504 for housing electronics components of the carbon capture device 502. It is clear in this side plane view 600 that additional modular components such as a heating element 604 and a fan unit 606 can be mounted within the housing 504. In the present embodiment, the heating element 604 is turned on when CO₂ needs to be released from the saturated, exposed carbon capture film. The fan unit 606 is configured to assist in directing airflow from the surrounding environment towards the carbon capture film for CO₂ capture and/or release. For example, the fan unit 606 may also work synergistically with the heating element 604 for directing heat or hot air towards the carbon capture film for releasing CO₂. Also shown in FIG. 6 is that a grating or grated opening 608 is provided at a lower back portion of the housing 504. The grating 608 allows air to flow through while keeping the back of the carbon capture unit from being exposed. This is useful to protect e.g. the fan unit 606 from being damaged by any external objects that may be drawn in by the fan unit 606. Although not shown in FIGS. 5 and 6, a roller speed control may also be provided to control a speed of the motor 514, and therefore a speed of the rollers 510, 512. This is one parameter which may be used for controlling a rate of CO₂ capture from and/or release to the surrounding air. Other parameters which may affect the rate of CO₂ capture and/or release include material properties or characteristics of the carbon capture film used and parameters of the surrounding environment (e.g. stagnant vs. non-stagnant condition). The speed of the rollers 510, 512 can therefore be adjusted taking into account these other parameters for controlling the rate of CO₂ capture and/or release.

FIGS. 7A and 7B show illustrations of a top plane view of the carbon capture device 502 of FIG. 5 in accordance with the fourth embodiment. FIG. 7A shows an illustration 700 of the top plane view of the carbon capture device 502 having a closed top with a housing lid 702. FIG. 7B shows an illustration 710 of the top plane view of the carbon capture device 502 with an opened top to show an arrangement of the heating element 604 and the fan unit 606 in the housing 504 of the carbon capture device 502.

FIG. 8 shows an illustration of a perspective back view 800 of the carbon capture device of FIG. 5 in accordance with the fourth embodiment. One of the fixtures 802 adapted to be connected to latches for mounting this portable carbon capture device 502 is shown in FIG. 8. In another embodiment, these fixtures 802 can also be adapted for connecting two or more carbon capture devices 502 to form an interconnected network of carbon capture devices 502 for carbon capture. In an embodiment, the fixture 802 include a gap which is adapted to allow easy removal of a part of the housing 502 or components of the carbon capture device (e.g. the grating 608).

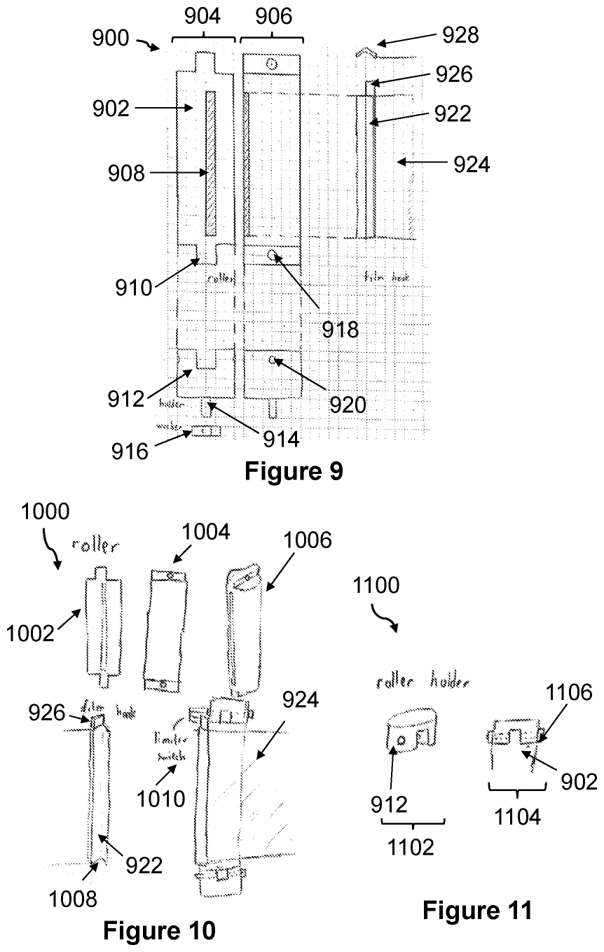

FIG. 9 shows illustrations 900 of a roller 902 and its attachments for use with the carbon capture device 502 of FIG. 5 in accordance with the fourth embodiment. The roller 902 can be one of the rollers 510, 512. The rollers 510, 512 are therefore removable rollers which can be detached from a carbon capture device.

FIG. 9 shows a frontal plane view 904 of the roller 902 and a side plane view 906 of the roller 902. As shown in the frontal plane view 904, the roller 902 has an elongated shape and comprises an elongated roller slot 908 along a longitudinal midline of the roller 902. The roller 902 also includes a protrusion 910 at each of the two ends of the elongated roller 902, where the protrusion 910 is adapted to be connected to a roller holder 912. As shown in the frontal plane view 904, the roller holder 912 has a complementary depression or slot for fitting the protrusion 910 so as to fixedly connect the roller holder 912 to the roller 902. The roller holder 912 has a holder protrusion 914 which is adapted to be inserted into a washer 916 adapted to fit and connect to e.g. the roller mount 506 of the carbon capture device 502. The side plane view 906 of the roller 902 shows more clearly how the roller 902 can be connected to the roller holder 912. As shown in the side plane view 906, the protrusion 910 of the roller 902 has a hole 918 located at a middle of a longitudinal side of the protrusion 910. A side of the roller holder 912 includes a complementary holder hole 920 adapted to overlap with the hole 918 when the roller 902 is connected to the roller holder 912. A securing pin or other securing means can then be inserted through the hole 918 and the holder hole 920 for securing the roller 902 to the roller holder 912. Also shown in FIG. 9 is a film hook 922 adapted to connect to an end of a carbon capture film 924. One way of connecting the end of the carbon capture film 924 to the film hook 922 is by using a clip but it should be appreciated that other connecting means may be used. The film hook 922 as shown is longer than the roller slot 908 and includes an extended portion 926 configured to hook onto an inner side of the roller slot 908 for securing the film hook 922 to the roller 902. Also shown in FIG. 9 is a spring-like resilient structure 928 which is adapted to aid the alignment and positioning of the carbon capture film when the carbon capture film is installed or connected to the roller 902.

FIG. 10 shows illustrations 1000 of different views of the roller 902 of FIG. 9 and an attachment of the carbon capture film 924 to the roller 902 using the film hook of FIG. 9, in accordance with an embodiment. FIG. 10 shows a frontal plane view 1002, a side plane view 1004 and a perspective view 1006 of the roller 902. The parts are similar to that described in relation to FIG. 9 and so the description of which is not repeated here for succinctness. FIG. 10 also shows a side view of the film hook 922 with the extended portion 926 and a hook depression 1008 adapted to be fitted to the inner side of the roller slot 908 for securing the film hook 922 with the carbon capture film 924 to the roller 902. Also shown in FIG. 10 is a limiter switch 1010. The limiter switch 1010 is adapted to determine a presence, a passing, a positioning and/or an end of travel of the carbon capture film. The limiter switch 1010 may also be adapted to define a limit of a travel of the carbon capture film.

FIG. 11 shows illustrations 1100 of a perspective view 1102 and a frontal plane view 1104 of the roller holder 912 for attaching to the roller 902 of FIG. 9 in accordance with an embodiment. More clearly shown in the frontal plane view 1104 is that once the roller 902 is fitted to the roller holder 912, a pin 1106 can be inserted through the hole 918 and the holder hole 920 for securing the roller 902 to the roller holder 912.

FIG. 12 shows a graph 1200 illustrating different carbon dioxide concentration profiles within a separation zone 1202 of a carbon capture device in accordance with an embodiment. The graph 1200 relates to a carbon dioxide concentration CO₂ concentration vs. a reaction coordinate. A reaction coordinate is a parameter in relation to a progression of a reaction (e.g. a carbon capture process or a carbon release process). In the present case, it may be in terms of duration (i.e. time) or a physical dimension (i.e. length, for example, when air flows from one end to the other end of the exposed portion of the carbon capture film in an embodiment). C_{bulk} on the y-axis of the graph 1200 is a concentration of CO₂ in an ambient surrounding of the carbon capture device (e.g. in a stagnant condition) or a concentration of CO₂ of a flow stream prior to entering the carbon capture device (e.g. in non-stagnant conditions). The CO₂ concentration exiting the separation zone is expected to be lower than C_{bulk} because CO₂ is captured by the carbon capture device from its surrounding air. In an embodiment (not shown in relation to FIG. 12) where the carbon capture device comprises a heating element and that the heating element is activated or turned on, the carbon capture device serves as a CO₂ source as aforementioned described, and the CO₂ concentration exiting the separation zone is likely to be higher than C_{bulk}. A demonstration of this is shown in relation to FIG. 15 below.

The separation zone is defined as a region around the carbon capture device where the CO₂ concentration differs from its ambient surrounding area or environment, or an incoming flow stream (e.g. non-stagnant conditions as described in relation to FIGS. 1A to 1D). The CO₂ concentration exiting the separation zone is expected to be lower than C_{bulk} during a CO₂ capture operation, and higher than C_{bulk} during a CO₂ release operation. A size or dimensions of the separation zone is governed by operating parameters of the carbon capture device (e.g., a rotating speed of the rollers or a conveying speed for exposing a carbon capture film using an exposure mechanism, an orientation of the carbon capture device etc.), flow conditions (e.g., CO₂ concentration, stagnant vs. non-stagnant conditions, a flow velocity etc.), and properties of the carbon capture film used in the carbon capture device (e.g., CO₂ capture capacity, CO₂ capture kinetics, texture of the carbon capture film etc.). The residence time and contact area of interaction between the surrounding environment (either static or dynamic) and the carbon capture film may dictate a concentration profile within this separation zone.

The various separation zone profiles shown in FIG. 12 are governed by both the carbon capture material characteristics and the surrounding environment. Using a carbon capture device of the present embodiments, the separation zone can be tailored to maximize carbon capture or release. As an example, comparing an untextured and a textured or porous carbon capture film of equivalent thickness, the textured or porous carbon capture film would have a steeper decline in CO₂ concentration over a shorter distance (e.g. a steeper decline in relation to the reaction coordinate as shown in FIG. 12). Therefore, to extend the separation zone over the exposed area of the carbon capture device, a more rapid conveyance (or a shorter exposure duration) would be beneficial. In another example, a thinner untextured film can reduce CO₂ concentration at a faster rate but to a lesser extent over longer durations compared to its thicker counterpart.

In an embodiment where a carbon capture film comprises a carbon capturing layer (i.e. an active layer) formed on another “inert” support layer, the initial reduction in CO₂ concentration for the thinner active layers would be much steeper over shorter durations. Consequently, the exposure duration can be reduced by at least 5 times to extend the separation zone across the exposed area of the carbon capture device. Increasing the active layer thickness would increase an extent of CO₂ reduction as the carbon capture film exits the separation zone.

In an embodiment where a carbon capture film comprises carbon capturing particles or colloids infiltrated within a porous support layer or layers, the reduction rate in CO₂ concentration (i.e., a slope of separation) would be much gentler. For example, to extend the separation zone, a longer exposure duration may be warranted. To increase an extent of CO₂ reduction (i.e. a change in CO₂ levels between the start and end of the separation zone), the amount of carbon capturing particles or colloids provided in the support layer or layers can be increased.

Further, as an example, in relation to FIG. 1B, where the carbon capture device is placed parallel to an incident air flow (e.g., laminar flow condition) with the carbon capture film moving in a co-current (parallel, same direction), the velocity and concentration profiles of the air flow and corresponding boundary layers are governed mainly by a speed of conveyance of the carbon capture film. It should be appreciated that different ambient conditions (e.g. stagnant vs. non-stagnant) and orientations of the carbon capture device will also yield different concentration profiles in the separation zone. Therefore, it should be appreciated that parameters in relation to (i) material properties of the carbon capture film, (ii) structural properties of the carbon capture film, (iii) operating conditions of the carbon capture device (e.g. conveyance speed of the carbon capture film, fan speed (if available for directing air flow towards the carbon capture film)) and/or heating temperature for carbon release operations), (iv) orientations of the carbon capture device (see descriptions above in relation to FIGS. 1A to 1D etc.), (v) dimensions of the carbon capture device and/or carbon capture film, and (vi) ambient conditions of the surroundings etc. can affect a concentration profile and a width of a separation zone. An example of a number of different concentration profiles are shown in FIG. 12. To maximize a drop in CO₂ concentration compared to the C_{bulk} for a carbon capture operation, it is desirable to configure the various aforementioned parameters so that the separation zone is as wide as possible.

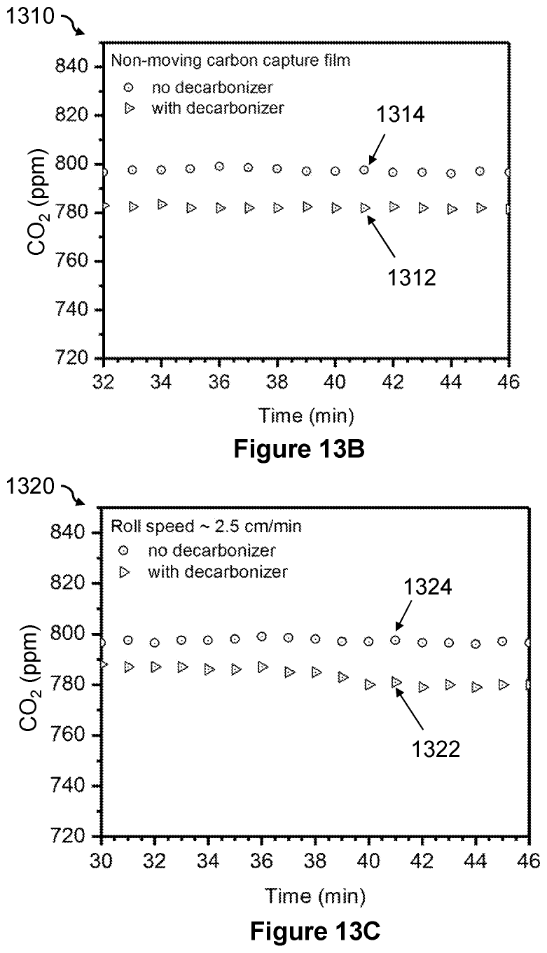

FIGS. 13A to 13C, FIGS. 14 and 15 show examples of various experimental results obtained from experiments performed to demonstrate an effectiveness of a carbon capture device. In these experiments, the carbon capture device of the third embodiment in relation to FIGS. 4A and 4B was used. In these experiments, a carbon capture film comprising a carbon capture composite (C3) film including a mixture of polyethyleneimine (PEI) and silica nano-particles was used. Details of this can be found in “Daniel Wirawan et. al. “Textured carbon capture composite (C3) films for distributed direct air capture in urban spaces”, Cleaner Engineering and Technology Vol. 4 100145, October 2021”, and this is incorporated herein by reference.

FIGS. 13A, 13B and 13C show graphs 1300, 1310, 1320 of carbon dioxide (CO₂) concentration versus time in a room with and without the use of a carbon capture device for various roll speeds in a lab setup in accordance with an embodiment. Identical sized rooms were used for cases with and without the use of a carbon capture device. For experiments in relation to the lab setup, a range of sizes of the carbon capture device was used. This includes a range of a planar area of the carbon capture device from 10 cm by 10 cm to 45 cm by 60 cm. A same size of the carbon capture device (e.g. 10 cm by 10 cm) was used for the results as shown in FIGS. 13A to 13C. FIG. 13A shows a graph of carbon dioxide concentration versus time where a carbon capture device has a roll speed of about 5 cm/min, FIG. 13B shows a graph of carbon dioxide concentration versus time for a non-moving carbon capture film, and FIG. 13C shows a graph of carbon dioxide concentration versus time where a carbon capture device has a roll speed of about 2.5 cm/min. The carbon dioxide concentration is measured in parts per million (ppm) and the time is in unit of minutes (min). After CO₂ was introduced at a constant flow of 0.5 mL/min and the CO₂ level had stabilized in the lab setup (takes about 30 minutes for CO₂ levels to stabilize), the film was conveyed from the storage to the receiver of the carbon capture device at varying speeds from 0 to 4-5 cm/min. This is shown in relation to FIGS. 13A, 13B and 13C. It is evident that an existence of a carbon capture device in the lab setup helped to maintain a CO₂ concentration level lower than that where there was an absence of a carbon capture device. As shown in FIG. 13A, the presence of the carbon capture device resulted in the measured CO₂ concentration 1302 maintained to that of below about 770 ppm, while the absence of the carbon capture device resulted in the measured CO₂ concentration 1304 being around 800 ppm. These results 1302, 1304 indicate that the carbon capture device is removing CO₂ from the lab setup. The lab results showed that to observed this difference (particularly the difference of ˜ 4% at around 38 min), the film speed must be at least 5 cm/min for the 100 μm thick film. The rise in CO₂ levels after the 44^{th} min was due to a shortage of film (film ran out). FIGS. 13B and 13C illustrate results for lower roll or conveyance speeds. At slower speeds of (e.g., 2.5 cm/min) (e.g. as shown in relation to FIG. 13C) or for a non-moving film (e.g. as shown in relation to FIG. 13B), a difference between CO₂ levels with a carbon capture device (e.g. plots 1322, 1312 respectively) and without a carbon capture device (e.g. plots 1324, 1314 respectively) was <2%.

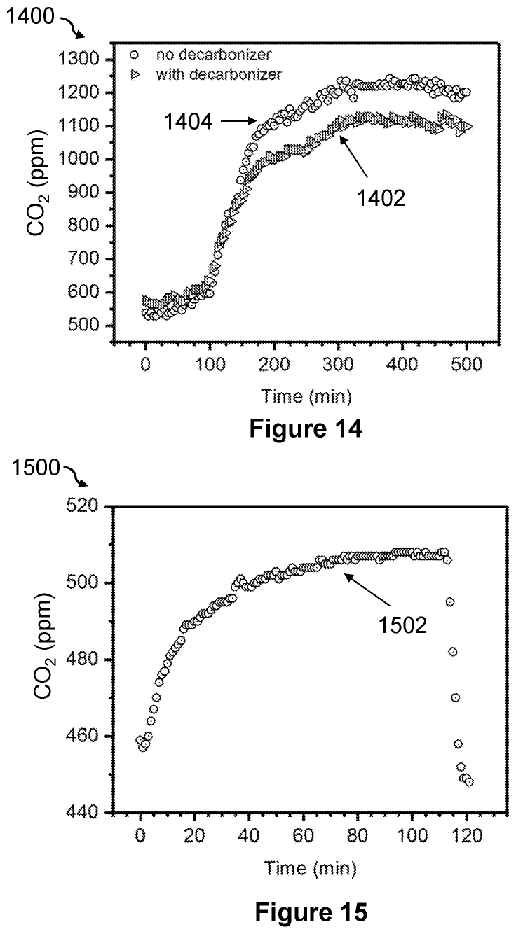

FIG. 14 shows a graph 1400 of carbon dioxide concentration versus time in a room with and without the use of a carbon capture device in a testing facility in accordance with an embodiment. Similar to the experiments conducted in relation to FIGS. 13A to 13C, identically sized rooms were used for experiments conducted with and without the use of a carbon capture device. For experiments in relation to the testing facility, a range of sizes of the carbon capture device was used. This includes a range of a planar area of the carbon capture device from 20 cm by 30 cm or 45 cm by 60 cm up to 2 m by 2 m. A planar area size of 20 cm by 30 cm of the carbon capture device was used for the results as shown in FIG. 14. For each of these, CO₂ was introduced at a same volumetric flow rate of 444 cm³/min. The results show ˜100-150 ppm reduction in the test cell where a carbon capture device was used. In the reference cell, no carbon capture device was used. Both rooms were otherwise operating under identical conditions. During the operation, the battery-powered carbon capture device would convey one roll of C3 carbon capture film from one side to the other at a controlled speed of ˜5 cm/min. The exposed C3 carbon capture film captures CO₂ from its surrounding, and the rolls were collected after use. As shown in FIG. 14, CO₂ was introduced into the test facility up to about the 300-minute mark on the y-axis of the graph 1400 where the CO₂ concentrations begin to saturate. The graph 1400 shows that the presence of the carbon capture device results in the measured CO₂ concentration 1402 to saturate at about 1100 ppm, while the absence of the carbon capture device results in the measured CO₂ concentration 1404 to saturate at about 1200 ppm (i.e. higher than that with the presence of the carbon capture device), reflecting the ˜100-150 ppm reduction in the test cell where the carbon capture device was used. These results 1402, 1404 indicate that the carbon capture device is removing CO₂ from the testing facility. The difference in the CO₂ reduction observed between the results as shown in FIGS. 13A and 14 can be related, among other factors, to a difference in an exposed area of the carbon capture devices used in these experiments which has an effect on a separation zone of each of these devices.

From the experiments (and other experiments conducted but not shown) above, CO₂ removal rates (CO₂ concentration per unit time) can be deduced to be governed by both properties of the carbon capture film and a working range of the carbon capture device. It is observed that the carbon capture device of the present embodiments was able to remove CO₂ from an ambient environment for CO₂ concentrations of at least 350 ppm. In some experiments, for capturing CO₂, an untextured carbon capture film of thickness ranging from 50 microns to 200 microns is exposed to its ambient environment for an exposure duration ranging from 15 to 120 minutes. The exposure duration is in relation to the time at which the portion of the carbon capture film is exposed to the ambient environment (e.g. in an embodiment where there is a window in a housing of the carbon capture device for exposing the carbon capture film, the exposure duration relates only to the time during which the portion of the carbon capture film is exposed through the window, i.e. any portion of the carbon capture film which resides in a compartment is not considered exposed). In an embodiment, a carbon capture device can be designed to operate a roll of carbon capture film for months depending on a carbon capture film used (e.g. material, thickness, structure etc.), a conveyance speed and ambient conditions etc. The exposure duration of the carbon capture film is controlled by a rotating speed of the rollers and a diameter of the carbon capture film roll. For textured films with nano-sized and/or micron-sized surface features, the exposure duration of these textured carbon capture film can be reduced by at least 2 times compared to the untextured carbon capture film. Surface textures of the carbon capture film may comprise geometrical features with characteristic lengths ranging from 100 nm to 200 microns and pattern densities ranging from 10 to 80%.

FIG. 15 shows a graph 1500 of carbon dioxide concentration versus time in a room where carbon dioxide is released from a carbon capture device in accordance with an embodiment. As described above, captured CO₂ in exposed, saturated carbon capture film of the carbon capture device can be released for potential CO₂ utilization by the application of heat. An example of an experimental result 1502 obtained is shown in the graph 1500 where it is observed that the CO₂ concentration increases from about 460 ppm at 0 minute to about 510 ppm at about 80 min with the release of CO₂ from the carbon capture device.

Other CO₂ release experiments were performed (not shown) and it is observed that the CO₂ release rate (CO₂ concentration per unit time) is governed by both the film characteristics and working range of the carbon capture device. The CO₂ release rate is also related to the separation zone and its dependent parameters as previously described. The carbon capture device is able to release CO₂ for a film surface temperature of the carbon capture film ranging from 45° C. to 130° C. In order to release CO₂, an untextured film of thickness ranging from 50 microns to 200 microns is exposed for durations from 30 minutes to 360 minutes. The exposure duration is controlled by a rotating speed of the rollers and a diameter of the carbon capture film roll. Similar to the case of CO₂ capture, for textured carbon capture films with nano-sized and/or micron-sized surface features, the exposure duration for CO₂ release can be reduced by at least 2 times compared to the untextured carbon capture film. Surface textures may comprise geometrical features with characteristic lengths ranging from 100 nm to 200 microns and patterns densities ranging from 10 to 80%.

It is clear from the foregoing that carbon capture device of the present embodiments is able to capture and/or release CO₂ from its ambient environment. Possible applications of the carbon capture device thus include both CO₂ capture and/or CO₂ release applications. A CO₂ removal product may be used for: (i) enclosed or confined spaces; (ii) poorly ventilated areas; (iii) locations with sudden surges of CO₂ e.g. bus stops; (iv) building with an air handling unit (AHU); (v) an open area (e.g. rooftops); (vi) a chemical plant; (vii) a power plant; and (viii) a data centre. The carbon capture device can also be used as an additional source of CO₂ by releasing the captured CO₂ from the carbon capture film. These can be applied, for example, in urban farms, CO₂ suppliers and food and beverages industry.

It is also clear from the afore-described Figures (e.g. FIGS. 3 to 11) how a carbon capture device of the present embodiments can be formed or manufactured. A skilled person in the art will be able to assemble the different components of the carbon capture device as described. For example, a carbon capture film can be attached to a roller 902 as shown in relation to FIGS. 9 and 11, and the roller 902 can be assembled with the housing of the carbon capture device using a roller holder 912. Gears can be connected to one end of the roller 902 which is then subsequently connected to a motor (see e.g. FIG. 3). The rollers may also be connected to each other using a conveyer belt. The motor, and optionally a fan and/or a heating element, can be electrically connected to a power supply (e.g. a battery). The motor may be adapted to rotate the rollers in at least one direction, e.g. to convey unexposed portion of a carbon capture film from a storage to a receiver for exposing a portion of the carbon capture film to capture CO₂ from the surroundings.

Although embodiments of the carbon capture device as described above includes a housing or a frame, it should be appreciated that in an embodiment, a carbon capture device comprising (i) a carbon capture film and (ii) an exposure mechanism including a receiver and a storage can be integrated with an infrastructure or building so that it may not be necessary to provide a housing or a frame to the carbon capture device as such. It should also be appreciated that other electronic components for example a motor is optional as it is possible to manually convey (e.g. using a rotatable handle connected to one or more of the rollers) unexposed portion of the carbon capture film to be exposed at regular intervals for capturing CO₂ from or releasing CO₂ to the surrounding environment. In an embodiment where CO₂ needs not be released to the surrounding environment, a heating element can also be omitted from the carbon capture device. It should also be appreciated that a fan unit of the carbon capture device is optional, particularly for non-stagnant conditions as aforementioned described.

Other alternative embodiments include: (1) one or more functional layers that can separate other gaseous molecules, liquids or particles from an incident air flow or ambient surroundings, either through condensation, absorption or filtration; (2) a motor speed controller connected to the motor for controlling a speed for conveying the unexposed portion of the carbon capture film from the storage to the receiver; (3) a power source, e.g. a portable power source such as a battery, for powering the motor and/or other components e.g. the fan unit and/or the heater element; (4) a direction controller for switching a rotation direction of the motor to cause the receiver to convey the exposed portion of the carbon capture film from the receiver to the storage; (5) the carbon capture film having a textured surface of various patterns and dimensions; (6) the exposure mechanism being not formed using two rollers, e.g. by using a bearing-based mechanism; (7) two elongated rollers for the exposure mechanism of the carbon capture device, where the two elongated rollers have longitudinal axes which are parallel to each other; (8) a power socket or plug for connecting a motor or other components (e.g. a fan unit and/or a heating element) of a carbon capture device to a DC or AC power source; (9) a carbon capture device which is configured to be portable or configured to be capable of integrating with a building or an infrastructure; (10) orientating a carbon capture device so that a longitudinal plane of a carbon capture film of the carbon capture device is parallel to an airflow direction of an incident airflow, and that a roll direction of the carbon capture film is at an angle to the airflow direction, where the angle includes an angle from 270° to 360°, 180° to 270°, 90° to 180°, or 0° to 90° or any other suitable angle; (11) orientating a carbon capture device so that a longitudinal plane of a carbon capture film of the carbon capture device is perpendicular to an airflow direction of an incident airflow (e.g. along a x-axis), and that a roll direction of the carbon capture film is an angle orthogonal to the airflow direction (e.g. an angle in the x-y plane), where the angle includes an angle from 270° to 360°, 180° to 270°, 90° to 180°, or 0° to 90° or any other suitable angle; (12) or orientating a carbon capture device so that a longitudinal plane of a carbon capture film of the carbon capture device is at an angle to an airflow direction of an incident airflow, the angle includes an angle from 0° to 45°, 45° to 90°, 90° to 135°, or 135° to 180° or any other suitable angle; (13) where a carbon capture film is mounted between a storage roller and a receiving roller, a motor is operationally connected to the storage roller for rotating the receiving roller and the storage roller; (14) other mechanism (other than the film hook and roller slot) of hooking or holding the capture carbon film to the exposure mechanism (e.g. rollers), such as the use of external attachment means (e.g. hooks or tapes or Velcro etc.) for attaching the carbon capture film to the exposure mechanism (e.g. rollers); (15) conveying the unexposed carbon capture film from a storage to a receiver of a carbon capture film using a conveyance speed or roll speed of 0 to 10 cm/min or 1 to 9 cm/min or 2 to 8 cm/min or 3 to 7 cm/min or 4 to 6 cm/min or 2.5 to 5 cm/min; (16) exposing the portion of carbon capture film for 5 min to 360 mins, or 10 min to 180 mins or 15 mins to 120 mins or 30 mins to 90 mins for carbon capture; (17) exposing the portion of carbon capture film for 5 min to 360 mins, or 10 min to 360 mins, 30 min to 360 mins or 15 mins to 120 mins or 30 mins to 90 mins for carbon release; (18) dimensions of a longitudinal planar area of the carbon capture device includes a range from 10 cm by 10 cm up to 2 m by 2 m, it should be appreciated that a carbon capture film mounting on such a device would have a similar (slightly smaller depending on e.g. a size of the frame of the carbon capture device or the exposure of the carbon capture device if present) surface area to this longitudinal planar area; (19) gears to operationally connect a motor of each of the two rollers of a carbon capture device for rotating the two rollers simultaneously, e.g. for maintaining a surface or film tension of the carbon capture film; and (20) controlling an exposure of a carbon capture film by either (i) continuous conveyance or rolling of the carbon capture film from a storage to a receiver of a carbon capture device (or vice versa) or (ii) pulsing or intermittent conveyance or rolling of the carbon capture film from a storage to a receiver of a carbon capture device (or vice versa). For a same exposure duration of a carbon capture film (so that a carbon capture performance of the carbon capture film is not materially affected) and having other parameters the same, controlling the exposure of the carbon capture film for case (ii) is more energy efficient than case (i).

Although only certain embodiments of the present invention have been described in detail, many variations are possible in accordance with the appended claims. For example, features described in relation to one embodiment may be incorporated into one or more other embodiments and vice versa.

1. A carbon capture device comprising:
a carbon capture film for capturing carbon dioxide; and
an exposure mechanism for exposing a portion of the carbon capture film to a surrounding environment for capturing carbon dioxide, the exposure mechanism comprising a receiver for receiving an exposed portion of the carbon capture film and a storage for holding an unexposed portion of the carbon capture film, wherein the receiver is adapted to be connected to a portion of a leading end of the carbon capture film and to convey the unexposed portion of the carbon capture film from the storage to the receiver for exposing the portion of the carbon capture film to the surrounding environment.

2. The carbon capture device of claim 1, further comprising a frame adapted to hold the carbon capture film and the exposure mechanism, the frame having an exposure window for exposing the portion of the carbon capture film.

3. The carbon capture device of claim 1, further comprising a receiver compartment for housing the exposed portion of the carbon capture film and a storage compartment for housing the unexposed portion of the carbon capture film.

4. The carbon capture device of claim 1, further comprising a fan for directing air flow from the surrounding environment towards the portion of the carbon capture film.

5. The carbon capture device of claim 1, further comprising a heater for providing heat to the exposed portion of the carbon capture film for releasing the carbon dioxide captured in the exposed portion of the carbon capture film, or one or more functional layers adapted to separate other gaseous molecules, liquids or particles.

6. (canceled)

7. The carbon capture device of claim 1, wherein the receiver and the storage are in the form of elongated rollers.

8. The carbon capture device of claim 7, further comprising a motor adapted to operationally connect to the receiver for causing the receiver to convey the unexposed portion of the carbon capture film from the storage to the receiver.

9. The carbon capture device of claim 8, further comprising a motor speed controller connected to the motor for controlling a speed for conveying the unexposed portion of the carbon capture film from the storage to the receiver, a power source for powering the motor, or a direction controller for switching a rotation direction of the motor to cause the receiver to convey the exposed portion of the carbon capture film from the receiver to the storage.

10. (canceled)

11. (canceled)

12. The carbon capture device of claim 1, wherein the carbon capture device includes a portable carbon capture device or is adapted to be integrated to an infrastructure.

13. (canceled)

14. The carbon capture device of claim 1, wherein the carbon capture film includes one or more of: a textured surface, a porous structure, a bilayer structure comprising a carbon capturing layer formed on an inert support layer and a plurality of carbon capturing particles mixed within a porous support layer.

15. A system comprising two or more of the carbon capture devices of claim 1 for capturing carbon from the surrounding environment.

16. A method of using a carbon capture device for carbon capture, the carbon capture device comprising a carbon capture film for capturing carbon dioxide and an exposure mechanism for exposing a portion of the carbon capture film to a surrounding environment for capturing carbon dioxide, the exposure mechanism comprising a receiver for receiving an exposed portion of the carbon capture film and a storage for holding an unexposed portion of the carbon capture film, the method comprising:
providing the unexposed portion of the carbon capture film to the storage;
connecting a portion of a leading end of the carbon capture film to the receiver; and
conveying the unexposed portion of the carbon capture film from the storage to the receiver for exposing the portion of the carbon capture film to the surrounding environment.

17. The method of claim 16, wherein the receiver of the carbon capture device includes an elongated receiving roller and the storage of the carbon capture device includes an elongated storage roller, the elongated receiving roller and the elongated storage rollers are placed parallel to each other.

18. The method of claim 17, further comprising providing the carbon capture device in a flat orientation wherein a longitudinal plane of the portion of the carbon capture film is parallel to an air flow direction of the surrounding environment.

19. The method of claim 18, further comprising providing the carbon capture device in a perpendicular orientation wherein a direction of conveyance of the unexposed portion of the carbon capture film from the storage to the receiver is perpendicular to the air flow direction, or providing the carbon capture device in a parallel orientation wherein a direction of conveyance of the unexposed portion of the carbon capture film from the storage to the receiver is parallel to the air flow direction.

20. (canceled)

21. The method of claim 17, further comprising providing the carbon capture device in an erected orientation wherein a longitudinal plane of the portion of the carbon capture film is perpendicular to an air flow direction of the surrounding environment.

22. (canceled)

23. The method of claim 16, further comprising:
conveying the exposed portion of the carbon capture film from the receiver to the storage; and
heating the exposed portion of the carbon capture film to release the captured carbon dioxide.

24. The method of claim 23, wherein heating the exposed portion of the carbon capture film includes heating the exposed portion of the carbon capture film to a temperature ranging from 45° C. to 130° C.

25. The method of claim 16, wherein the carbon capture film includes an untextured surface and having a thickness ranging from 50 micrometres to 200 micrometres, the method further comprises exposing the portion of the carbon capture film for 15 minutes to 120 minutes.

26. The method of claim 16, further comprising conveying the unexposed portion of the carbon capture film from the storage to the receiver with a conveyance speed of 2.5 to 5.0 centimetre per minute (cm/min).
